(19) United States
(12) Patent Application Publication
(10) Pub. No.: US 2017/0275145 A1
(43) Pub. Date: Sep. 28, 2017

(54) SAFETY SYSTEM FOR MOBILE APPARATUS

(71) Applicant: FORKLIGHT LIMITED, Felixstowe, Suffolk (GB)

(72) Inventor: Jonathan Paul LAKER, Felixstowe, Suffolk (GB)

(73) Assignee: FORKLIGHT LIMITED, Felixstowe, Suffolk (GB)

(21) Appl. No.: 15/508,755

(22) PCT Filed: Jul. 1, 2015
(86) PCT No.: PCT/GB2015/051929

§ 371 Date: Mar. 3, 2017

(30) Foreign Application Priority Data
Sep. 5, 2014 (GB) 1415821.6

(51) Int. Cl. B66F 17/00; B66F 9/075

(52) U.S. Cl. CPC B66F 17/003; B66F 9/07504

(57) ABSTRACT

A forklift arrangement having a main body (12) and at least one elevating fork (24), including a light-emitting arrangement (40) fixed with respect of a side surface of the elevating fork.

### FIELD OF THE INVENTION

This invention relates to a forklift apparatus for movement over a ground surface, the apparatus having a main body and a pair of lifting forks, and has particular, but not exclusive, application to forklift trucks (also referred to as forklifts).

### BACKGROUND TO THE INVENTION

Modern forklifts are well known and are available in a range of sizes and designs depending on required application. For example, a standard industrial counterbalanced forklift comprises a main chassis, wheels, guard, weight, mast, carriage and lifting forks. The operator sits in a seat located on the main chassis and is protected by the surrounding guard. All the controls for steering, lift, tilt and side shift etc are located in front of the operator and foot pedals are provided for acceleration and braking.

The mast is mounted at the front of the chassis, the mast being pivotable so it can tilt forward or backwards under the control of one or more hydraulic rams. The carriage assembly is mounted on the mast and runs up and down in a roller/channel arrangement and is normally operated by a hydraulic ram. One or more lifting forks are attached to the carriage so they move up and down with the carriage under the control of by the hydraulic ram, moving from a lowered position at or near the ground to a raised position, e.g. up to about 4 m above the ground. Provision is normally provided to alter the lateral spacing between the forks to allow the forklift to pick up items of different sizes, with adjustment being manual or by the use of hydraulic rams. On the rear of the chassis a large weight is attached which counterbalances the load being lifted by the forks.

The lifting forks are designed to locate in the aperture between the two vertically spaced decks of a pallet (approximately 100 mm apart) or directly under loads, and each fork normally has a maximum thickness in the vertical direction of around 40 mm at the rear tapering to around 15 mm at the front, distal end, with a width (in plan) of 100 mm or 125 mm in the case of a standard 2.5 ton forklift. Depending on machine size and application these dimensions will vary accordingly.

Forklifts are used in many different locations internally, externally, underground and under various lighting conditions and it is common practice to fit the forklift with an amber warning beacon on top of the guard at the rear to attract the attention of people in the vicinity when the forklift is in operation.

Forklifts can also be fitted with one or more work lights normally located on the front of the guard or mast at head height of the operator to illuminate the surrounding area.

Considering the side view of a forklift, the main body, comprising the main chassis, wheels, guard, weight, mast and carriage, has a compact rectangular shape and is easily visible, whereas the forks, which project beyond the footprint of the main body, are much less visible, normally being dark in colour, e.g. black, being very thin in profile and possibly being located at any vertical position between ground level and the top position on the mast. When a forklift is moving without a load, the forks are normally positioned around 100 to 300 mm above the ground to prevent the forks scraping. If the forklift is operating in a low light level environment or adverse weather conditions for example heavy rain or fog with its work lights on, it can be very difficult for persons around to see the position of the forks, as the work lights are usually very intense and can be blinding especially when the forklift is approaching the person or turning towards them, and a person can be seriously injured or killed if they are struck by one or more forks of the machine itself. Furthermore, because the forks protrude from chassis, if the forklift is emerging from behind an obstruction, the main body and in particular the warning beacon will not become visible until the forklift has emerged a substantial distance from behind the obstruction, with the distance from the leading end of the forks to the warning beacon being about 2.5 m in a typical case, presenting a further safety hazard.

The present invention aims to address such safety problems.

### SUMMARY OF THE INVENTION

The present invention relates to a new safety system that can be integrated into any lifting forks/tines that are used on various configurations of forklifts including mast type counter balanced forklifts, telescopic handling forklifts, off road machines, vehicles with hydraulic arms (HIABs) with lifting forks offering a high visual awareness of the machine and the position of the forks to surrounding traffic and pedestrians.

The safety system can be integrated in to many styles of side-by-side lifting forks including standard forks, bespoke forks, that are used with a fork lift and other lifting machinery.

In one aspect, the present invention provides a forklift apparatus for lifting a pallet or load, the apparatus comprising a self-propelled main body on ground-engaging wheels, a pair of similar side-by-side lifting forks for lifting said pallet or load, a light-emitting arrangement and a control system, wherein;
the main body comprises a mast and a carriage, the carriage being mounted on the mast for movement between a lowered position at or near the ground and a raised position;
said lifting forks are attached to the carriage to move up and down with the carriage between said lowered and raised positions, each lifting fork being elongate in a direction extending away from the main body and each having an outer side surface projecting beyond the footprint of the main body;
the angle of the mast with respect to vertical is adjustable;
the light-emitting arrangement comprises a pair of elongate light strips, each light strip being fixed with respect to a corresponding one of said outer side surfaces along the length of said lifting forks so as to be visible from both sides; and the control system is configured to:
(a) operate the light strips in different modes, said modes comprising a flashing mode in which a flashing light is visible from both sides of said lifting forks for warning pedestrians and a static mode in which an outwards illumination is provided from both sides of said lifting forks when engaging said lifting forks with said pallet or load; and
(b) operate the light strips in the flashing mode for warning pedestrians until the control system detects that said lifting forks have been raised or lowered or the mast angle has been altered and then to operate the light strips in the static mode for a set period of time for helping position said lifting forks in the correct alignment with a pallet or load to be lifted.

In another aspect, the present invention provides a method of operating a forklift apparatus, the apparatus comprising a self-propelled main body on ground-engaging wheels, a pair of similar side-by-side lifting forks for lifting a pallet or load, a light-emitting arrangement and a control system, wherein;
the main body comprises a mast and a carriage, the carriage being mounted on the mast for movement between a lowered position at or near the ground and a raised position;
said lifting forks are attached to the carriage to move up and down with the carriage between said lowered and raised positions, each lifting fork being elongate in a direction extending away from the main body and each having an outer side surface projecting beyond the footprint of the main body;
the angle of the mast with respect to vertical is adjustable;
the light-emitting arrangement comprises a pair of elongate light strips, each light strip being fixed with respect to a corresponding one of said outer side surfaces along the length of said lifting forks so as to be visible from both sides; and
wherein the method comprises using the control system to:
(a) operate the light strips in a flashing mode in which a flashing light is visible from both sides of said lifting forks for warning pedestrians as the self-propelled main body moves across the ground; and
(b) detect when said lifting forks have been raised or lowered or the mast angle has been altered and then to operate the light strips in a static mode to provide outwards illumination from both sides of said lifting forks for a set period of time to help position said lifting forks in the correct alignment with a pallet or load to be lifted.

By having a light-emitting arrangement on the projecting side surface of the pair of lifting forks, the visibility of the pair of lifting forks is enhanced thus improving the conspicuousness and visibility of the apparatus and the position of the component to surrounding traffic and pedestrians, enabling greater visual awareness, so improving safety. In particular, in circumstances where the main body (which is more conspicuous) is concealed, e.g. behind a wall or other obstruction, but the pair of lifting forks is exposed, e.g. protruding from the wall or other obstruction, and represents a potential hazard, particularly if positioned below eye level and so being less likely to be observed, the light-emitting arrangement substantially improves the conspicuousness and visibility of the component so reducing the likelihood of collision and improving safety.

The forklift apparatus is typically a land (road) vehicle, having ground-engaging wheels, e.g. comprising a forklift truck or other lifting machine e.g. as noted above.

The forklift apparatus is self-propelled, and is powered by various means including an electric motor with associated batteries, LPG/diesel combustion engine, etc.

The lowered position of the pair of lifting forks is typically in the vicinity of the ground, e.g. being spaced say 100 to 300 mm above the ground, with the raised position possibly being up to several meters above the ground, typically about 4 metres in the case of a standard 2.5 ton forklift.

The pair of lifting forks may move with a linear motion, as with the forks of a forklift truck moving generally vertically along the carriage.

The pair of lifting forks, at least in the lowered position, typically extends from the main body in a direction generally parallel to the ground.

Each lifting fork is elongate in a direction extending away from the main body, usually in a direction generally parallel to the ground (at least in the lowered position).

The projecting side surface is thus preferably of elongate form, having the major dimension extending away from the main body (typically horizontally) and the minor dimension extending transversely thereto (typically vertically), with the light-emitting arrangement preferably also being elongate in the same direction. The invention finds particular application in cases where the aspect ratio of length to height or the projecting side surface is at least 10:1, preferably at least 15:1, more preferably at least 20:1. In the case of a standard 2.5 ton forklift fork this aspect ratio typically varies from 27.5:1 (1100 mm:40 mm) to 75:1 (1100 mm:15 mm). In broad terms, the aspect ratio is typically in the range 100:1 to 5:1 depending on the application.

The light-emitting arrangement is thus also elongate, desirably having an aspect ratio of at least 5:1, preferably 10:1, more preferably at least 15:1, yet more preferably at least 20:1, being longer in the horizontal direction than the vertical direction. In the case of an arrangement for use with a standard forklift 1100 mm length fork, the aspect ratio is preferably 100:1 (900 mm:9 mm). Overall the aspect ratio is typically in the range 2:1 to 1000:1 depending on the application.

The light-emitting arrangement preferably extends from the distal end portion (i.e. from the tip at the free end) of the lifting fork side surface, more preferably extending along substantially the full length of the projecting side surface.

The light-emitting arrangement is provided on the outer side surface of each of the lifting forks so as to be visible from both sides. The light-emitting arrangements on the lifting forks may be the same as each other or different.

One or more further light-emitting arrangements may optionally be provided on other parts of the lifting forks, e.g. on the front surface of the distal end.

The light-emitting arrangement suitably comprises one or more light sources. In the case of a light-emitting arrangement of elongate form, this may comprise a linear array of light sources, possibly mounted on a support, and may be referred to herein as a light bar or light strip.

The light-emitting arrangement conveniently comprises one or more LEDs (light-emitting diodes), e.g. mounted on a printed circuit board (which may be rigid or flexible). Where of elongate form, this may be referred to herein as an LED strip.

In a preferred embodiment, the light-emitting arrangement is in the form of an LED strip comprising a flexible printed circuit board carrying a linear array of LEDs. The LEDs are preferably surface mounted but may be through hole.

In place of a flexible LED strip, the light-emitting arrangement may alternatively comprise
1. A solid printed circuit board carrying surface mount/through hole LEDs;
2. One or more LEDs mounted in holders;
3. One or more filament lamps mounted in holders;
4. One or more discharge lamps mounted in holders;
5. One or more filament lamps mounted on a printed circuit board;
6. One or more discharge lamps mounted on a printed circuit board;
7. Electroluminescent panels; or
8. Fibre optic technology.

The light sources e.g. LEDs of a particular light-emitting arrangement may be all the same colour, e.g. white or red, may be a mixture of colours e.g. white and red, each colour being independently controllable, or may be RGB (red/blue/green) LEDs enabling production of red, blue or green light or a full spectrum of colours including white, or may be a combination of the above.

The light-emitting arrangement should be capable of outputting sufficient light to be clearly visible and conspicuous, and is desirably able to produce an output of at least 100 candela, preferably at least 300 candela, yet more preferably at least 500, 600 or 800 candela. The output, particularly for an LED strip, is typically in the range 400 to 1200 candelas per meter. As LED technology improves, this may increase.

The light-emitting arrangement may be arranged to produce light of constant or varying intensity, e.g. flashing on-off, possibly of the same or different colours. For example, the light-emitting arrangement may produce constant red light (e.g. from one or more red LEDs) or constant white light (e.g. from one or more white LEDs) in different circumstances.

The forklift apparatus may include a suitable control arrangement for regulating light output, particular colour, intensity, pulse pattern, flash rate etc. This may be a simple control system, with the light-emitting arrangement activated when the apparatus is activated. More complex arrangements are also possible, with the light-emitting arrangement being controlled to operate in different modes depending on the condition of the apparatus, e.g. stationary or moving, the degree of elevation of the pair of lifting forks etc. The emitted light intensity can be set by user-operated switches or by programming etc.

The apparatus may include a power supply for the light-emitting arrangement. This may conveniently be a power source for powering operation of the mobile apparatus. Alternatively a separate power supply may be provided, e.g. a battery (rechargeable or otherwise) mounted on the apparatus.

Suitable circuitry and connections are provided as required.

The light-emitting arrangement is suitably fixed with respect to the side surface of each lifting fork, and may be formed integrally therewith or secured thereto. Typically, however, the light-emitting arrangement, e.g. light bar or light strip such as an LED strip, is secured to the surface, possibly in a recessed portion of the surface, e.g. by use of adhesive, fasteners, screws or clips etc.

Optional protective covering may be provided over the light-emitting arrangement, particularly where the arrangement is located in a recessed portion of the surface, e.g. in the form of a cover member, for example of transparent or translucent plastics material, such as perspex, polycarbonate, etc., or apertured metal, suitably secured in position e.g. by welding, adhesive or use of screws, clips or other fasteners etc. In a preferred arrangement the light-emitting arrangement and protective covering are both located within a recessed portion of the side surface so as not to protrude therefrom. Alternatively, light sources, e.g. LEDs, LED strips, etc. may be encapsulated in transparent or translucent resin, silicon or other suitable material (possibly clear or coloured), providing protection against mechanical damage, moisture, weather, etc.

We will now consider the invention applied to a standard industrial counterbalanced fork lift, by way of illustration

The invention may consist of one or more integrated light bar(s) located within the forks. The light bars can be integrated on the external side and front edges of the forks, offering approximately 240-300 degree of visual awareness of the forklift, including the position of the forks to pedestrians and other forklift operators.

The light-emitting arrangement may comprise a light bar or strip consisting of a flexible printed circuit board containing surface mount LEDs located within a recessed section on the external edge of the forks.

Provision is optionally provided to protect the LED strip in operation and this can be provided by encapsulation in a transparent or translucent resin etc. to protect against impact and moisture. Alternatively a plastic cover or metal cover with apertures can be fitted flush or in a recess to provide mechanical protection. The covers can be retained in a groove, welded or attached with fasteners or adhesives.

The LED strip can be configured with one or more circuits so different LEDs can easily be controlled independently; for example red and white LEDs can be connected to different circuits so that by connecting one circuit the strip is red and by connecting the other circuit the strip is white.

RGB LEDs can be utilised offering the primary colours when connected directly, as well as the full spectrum of colours including white by varying the intensity of each colour.

The LED strip can contain one or more single colour LEDs or be fitted with RGB LEDs or a combination of RGB LEDs and single colour LEDs, for example white.

The LED strip could be digitally controlled and addressed via a bus network so that each individual LED or group of LEDs is individually controllable for colour and intensity.

The system could be controlled with a basic control system, so that when the forklift ignition is on the strip is illuminated either flashing or permanent. The flash pattern and rate can be set by switches or programming. When the ignition is switched off, then the strip is powered off.

The system could be controlled with an integrated control system so that when the when the ignition is operated, the light bars flash one colour, for example red offering a high visual indication to pedestrians that a forklift is approaching and the position of the forks. The flash pattern and rate can be set by switches or programming.

When a pallet is to be loaded the operator positions the forklift in the correct position, raises or lowers the forks and adjusts the angle of the mast to align the tips of the forks with a pallet aperture. The integrated control system optionally detects if the forks have been raised or lowered or the mast angle altered and changes the light bars from flashing red to permanent white for a set period of time for example 20 seconds providing a “precision” work light allowing the operator to quickly and safely position the forks in the correct alignment reducing the risk of the forks pushing the pallet backwards, dislodging the pallet or a pallet directly behind it creating a serious hazard to the fork lift operator any workers or pedestrians in the vicinity. The set period of time can be from 0.1 to 6000 seconds.

The integrated control system could automatically return to flashing red before the timer has elapsed if it has detected the forklift was moving at a predetermined speed.

The integrated control system could also be configured to allow all or selected LEDs to remain illuminated at full brightness or dimmed when the ignition is off and the forklift is parked up.

With respect to colour, flash rate and flash pattern there has been much research on conspicuity, that is the capacity of a stimulus to be noticed when the observer is not actually looking for it. The Loughborough University Institutional Repository report on Motor vehicle and pedal cycle conspicuity—Part 3 vehicle mounted warning beacons, includes the following conclusions:

### Daytime Conditions

Colour—In general, red and blue performed the best over all tests. They caused the least discomfort glare and annoyance and were ranked better than amber for conspicuity (objective and subjective measures). Green performed the best in terms of conspicuity, but performed worse than all other colours in terms of discomfort glare and annoyance. Overall, amber performed the worst over all tests. It performed the worst in terms of conspicuity and only green was worse than amber in terms of causing discomfort glare and annoyance.
Flash rate—Beacons with flash rates 120 fpm (flashes per minute) and 180 fpm performed the best.
Single verses double pulse strobes—Double pulse strobe beacons performed better than single pulse in terms of conspicuity

### Night-Time Conditions

Colour—In general, the colour red performed the best over all tests. It was ranked the best for conspicuity (reaction time and number of correct beacon detections), caused less disability glare than amber and green, and gave rise to the least discomfort glare and annoyance, even at maximum intensities. Amber performed the worst over all tests. It was rated one of the worst for conspicuity and only green was worse than amber in terms of causing disability and discomfort glare and annoyance.
Flash rate—Beacons with flash rates 120 fpm and 180 fpm performed the best.
Single verses double pulse strobes—Double pulse strobe beacons performed better than single pulse in terms of conspicuity

Based on the findings of the report, in order to provide maximum conspicuity, it is preferred to use a LED strip of red, blue, green or red and flash rate between 1-4 Hz (60-240 fps) on a single pulse and 1-3 Hz (60-180 fps) on a double pulse pattern. Further possibilities for good conspicuity include flashing red/blue/green, red/blue, blue/green or red/green.

The LED strip can also utilise other colours, flash rates (0.1-100 Hz) and other patterns if required depending on application.

The report also considered appropriate light intensity for day time and night time use for good conspicuity, and recommends light outputs as follows:
Day: 800 to 1000 candela
Night: 325 to 425 candela

It is accordingly preferred to use a light-emitting arrangement operable to produce such output.

Preferably the apparatus includes a sensor arrangement that can determine ambient lighting conditions and regulate light output from the light-emitting arrangement, preferably to produce light outputs within the ranges specified above in appropriate conditions.

Provision is provided to connect the light bars to the main forklift electrical system through the mast/carriage assembly. Channels/holes are provided in the forks to carry the supply cables to a plug and socket arrangement, automotive connectors or other suitable means.

Alternatively the LEDs and control system can be powered by a rechargeable or non-rechargeable power pack mounted on the carriage or mast assembly. The rechargeable power pack/control system can also be integrated within the fork itself by machining a suitable aperture and securing a cover plate. The rechargeable power pack can be charged by an external system or connected to the forklift's main power supply directly by a set of contacts which align when the forks are in a certain position or non contact for example an inductive coil arrangement or any other suitable means.

The light-emitting arrangement may be retrofitted to an existing mobile apparatus, or initially included in the apparatus.

Preferred and option features of this aspect are as discussed above in connection with the mobile apparatus.

Optional and preferred features of these aspects of the invention as discussed above.

### BRIEF DESCRIPTION OF THE DRAWINGS

Embodiments of the invention will now be described, by way of illustration, with reference to the accompanying drawings, in which:

FIG. 1 is a side elevation of a conventional counterbalanced forklift;

FIG. 2 is an isometric view of illuminated forks in accordance with one embodiment of the invention;

FIG. 3 is an enlarged isometric end section of one of the forks of FIG. 2;

FIG. 4 is an isometric view of illuminated forks in accordance with a further embodiment of the invention;

FIG. 5 is an enlarged isometric end section of one of the forks of FIG. 4;

FIG. 6 is an isometric view of a retrofit illuminated fork of another embodiment of the invention;

FIG. 7 is an enlarged isometric end section of the retrofit illuminated fork of FIG. 6;

FIG. 8 is a side elevation of a counterbalanced forklift in accordance with the invention;

FIG. 9 is a block diagram of a basic control system of a forklift in accordance with the invention; and

FIG. 10 is a block diagram of an integrated control system of a forklift in accordance with the invention.

### DETAILED DESCRIPTION OF THE DRAWINGS

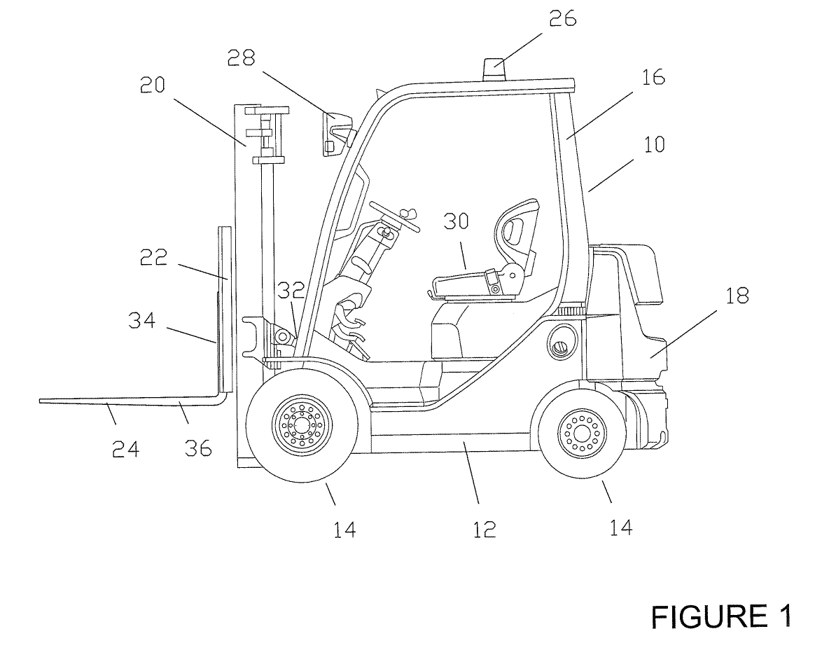

FIG. 1 illustrates a conventional counterbalanced forklift 10 comprising a main chassis 12 on which are mounted four ground-engaging wheels 14, cab guard 16, counterweight 18 and mast 20. Carriage 22 is mounted on the mast for linear movement in a vertical direction in a roller/channel arrangement under the control of a hydraulic ram (not shown). A pair of similar lifting forks 24 are attached to the carriage to move up and down with the carriage, moving from a lowered position at or near the ground to a raised position, e.g. up to about 4 m above the ground. FIG. 1 shows the forks in an intermediate position, fairly near the ground. A warning light 26 and one or more worklights 28 are mounted on the guard 16.

The operator sits in a seat 30 located on the main chassis and is protected by the surrounding guard. All the controls for steering, lift, tilt and side shift etc are located in front of the operator and foot pedals are provided for acceleration and braking. The mast 20 is pivotable so it can tilt forward or backwards under the control of one or more hydraulic rams 32.

The forks 24 are of L-shape, having a vertical fixing limb 34 for securing to the carriage 22 and a horizontal lifting limb 36.

The forks 24 are retained on the carriage 22 with a dovetail configuration or other means allowing them to be moved inwards or outwards for adjustment of the lateral spacing between the forks to allow the forklift to pick up items of different sizes, with adjustment being manual or by the use of hydraulic rams.

The lifting forks 24 are designed to locate in the aperture between the two vertically spaced decks of a pallet (approximately 100 mm apart) or directly under loads. The lifting limb 36 has a maximum thickness in the vertical direction of around 40 mm tapering to around 15 mm at the front, distal end with a width (in plan) of 100 mm (or 125 mm in some embodiments). The length of the lifting limb 36 is 1 m. Depending on machine size and application these dimensions will vary accordingly.

As can be seen, the lifting limbs 36 of the forks 24 project beyond the footprint of the main body (comprising the main chassis, wheels, guard, weight, mast and carriage) and constitute a potential hazard as discussed above.

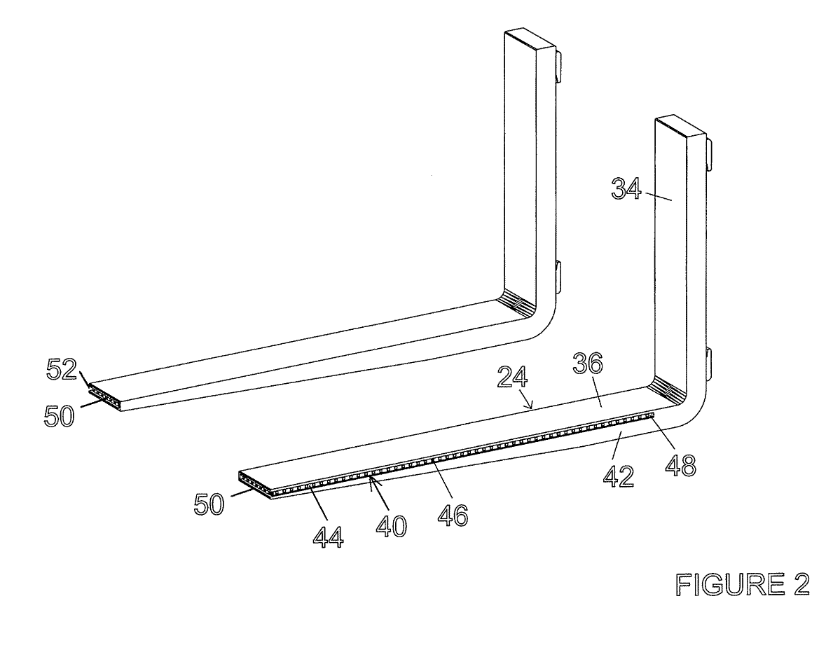

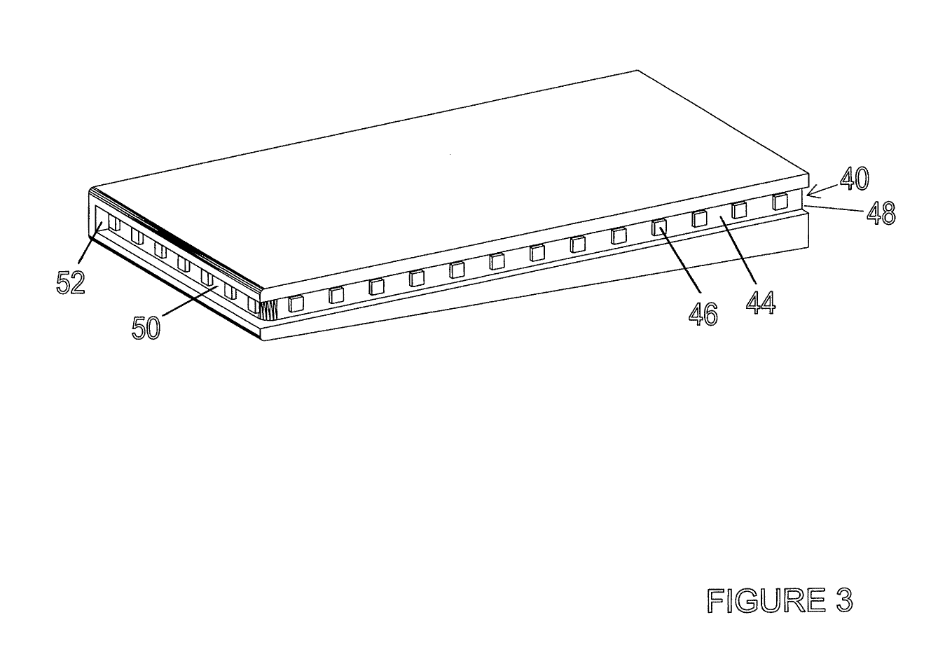

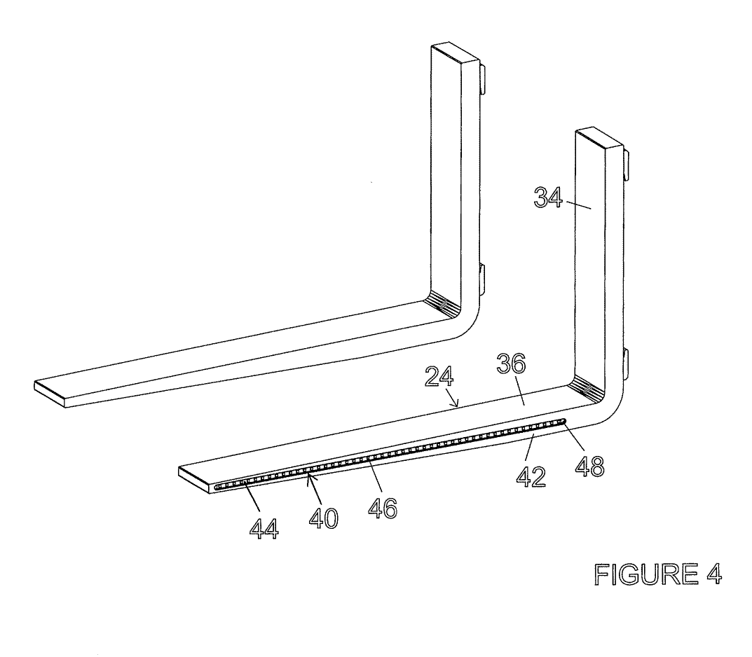

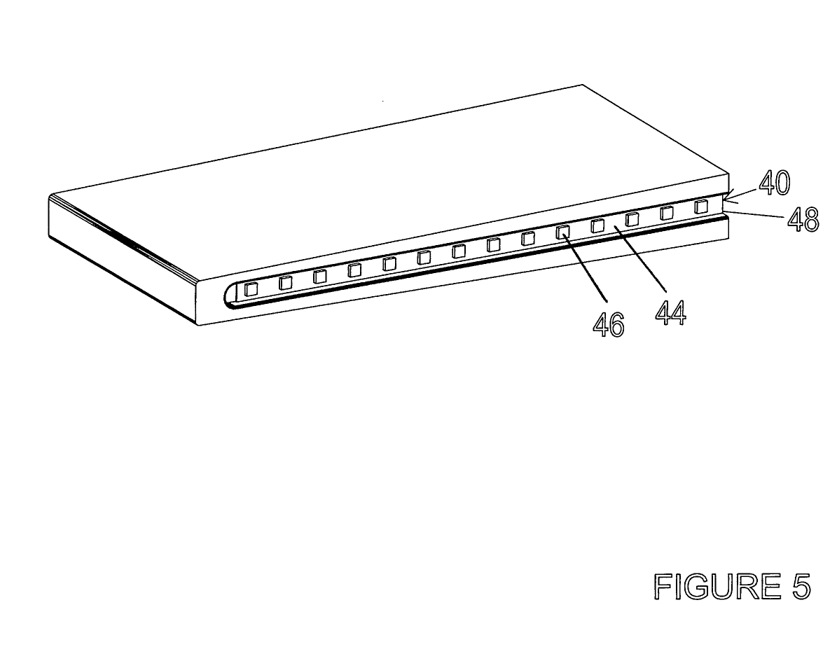

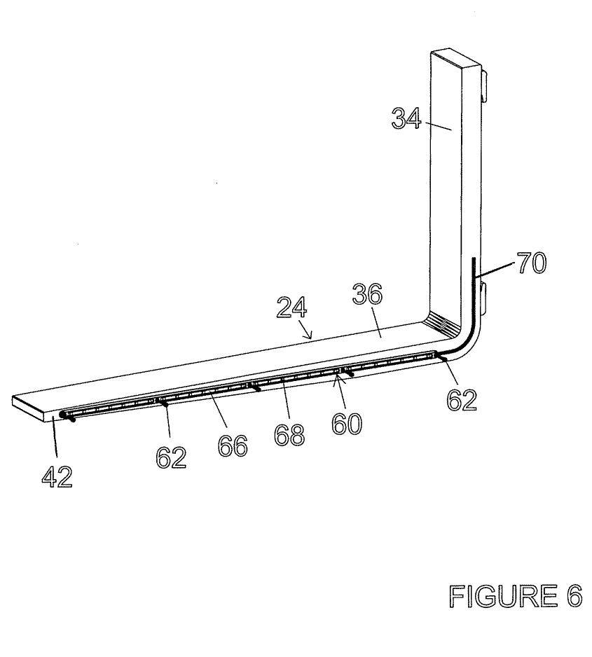

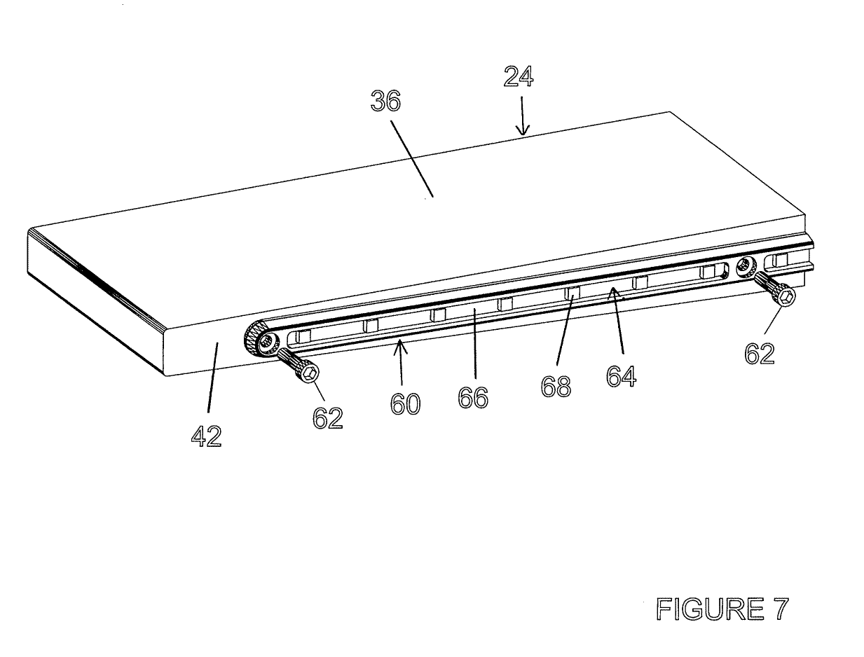

In accordance with the invention, the forks 24 of the forklift of FIG. 1 may be replaced by modified forks in accordance with the invention, e.g. as in the embodiment of FIGS. 2 and 3 or the embodiment of FIGS. 4 and 5 to be discussed below. The modified forks may correspond largely to the conventional forks 24, save for the addition of light-emitting arrangements and associated circuitry, etc., and corresponding parts have the same reference numbers in the figures. Alternatively, existing forks such as the forks 24 of the FIG. 1 may be modified by retrofitting a light-emitting arrangement, as shown in FIGS. 6 and 7.

In the forks of FIGS. 2 and 3 a light-emitting arrangement in the form of an LED strip 40 is secured to the outer side surface 42 of each fork lifting limb 36, to extend along substantially the full length thereof. FIG. 2 shows the LED strip secured to the nearside surface of the closer fork 24, with a similar LED strip (not visible in FIG. 2) being secured to the far side surface of the furthermost fork. The LED strip comprises a support in the form of an elongate thin flexible printed circuit board 44 carrying a linear array of surface mounted LEDs 46 along its length, the LEDs being illuminated when power is supplied. The LED strip 40 is mounted in a recessed slot 48 (seen best in FIG. 3) in fork side surface 42, being affixed by double sided adhesive tape, adhesive, screws, clips or any other suitable means.

A similar, but shorter, respective LED strip 50 is similarly secured to the end surface of each fork lifting limb in a recessed slot 52.

The LED strip 40 is shown parallel to the top surface of the fork, but this can be arranged at an angle to run in the approximate centreline of the fork taper as shown in FIGS. 4 and 5 if required.

To provide additional protection, the LED strip 50 could alternatively be located within an aperture located parallel behind the end surface of the fork, apertures are provided cross axially to allow the LEDs to shine through in the end surface.

In a typical embodiment with a fork of the dimensions discussed in connection with FIG. 1, each LED strip 40 has a length of 900 mm and a height of 8 mm and each LED strip 50 has a length of 100 mm and a height of 8 mm.

Provision is provided to connect the LED strips to the main forklift electrical system through the mast/carriage assembly. Channels/holes are provided in the forks to carry the supply cables to a plug and socket arrangement, automotive connectors or other suitable means.

Alternatively the LEDs and control system can be powered by a rechargeable/non rechargeable power pack mounted on the carriage or mast assembly. The rechargeable power pack can be charged by an external system or connected to the forklifts main power supply directly by a set of contacts which align when the forks are in a certain position or non-contact for example an inductive coil arrangement or any other suitable means.

FIGS. 4 and 5 illustrate a further embodiment of illuminated forks in accordance with the invention that are very similar to the forks of FIGS. 2 and 3, with corresponding components having the same reference number, but lacking the recessed LED strips in the fork end surfaces.

In the arrangements of FIGS. 2 and 3 and 4 and 5 the forklift forks are initially produced with the light-emitting arrangement in place, i.e. these are integrated arrangements.

FIGS. 6 and 7 illustrate an embodiment of light-emitting arrangement intended to be retrofitted to an existing forklift fork such as fork 24 of FIG. 1.

As illuminated elongate rail 60 is affixed to the outer side surface 42 of the fork lifting limb 36 to extend substantially along the length thereof, e.g. using a number of linearly spaced screw fixings 62. The rail contains an LED strip 64 (corresponding to LED strip 40) comprising, a thin, flexible printed circuit board 66 carrying a linear array of surface mounted LEDs 68 along its length. A power supply cable 70 extends from the rear of the strip 64, passing along the fork outer surface for connection to the main forklift electrical system.

The rail 60 can be manufactured from a variety of materials and can be cast, extruded, moulded, machined or fabricated and provides protection for the LEDs whilst the forklift is in operation.

Before fitting the rail 60 a stepped elongate recess may optionally be made in the fork surface to accommodate the rail.

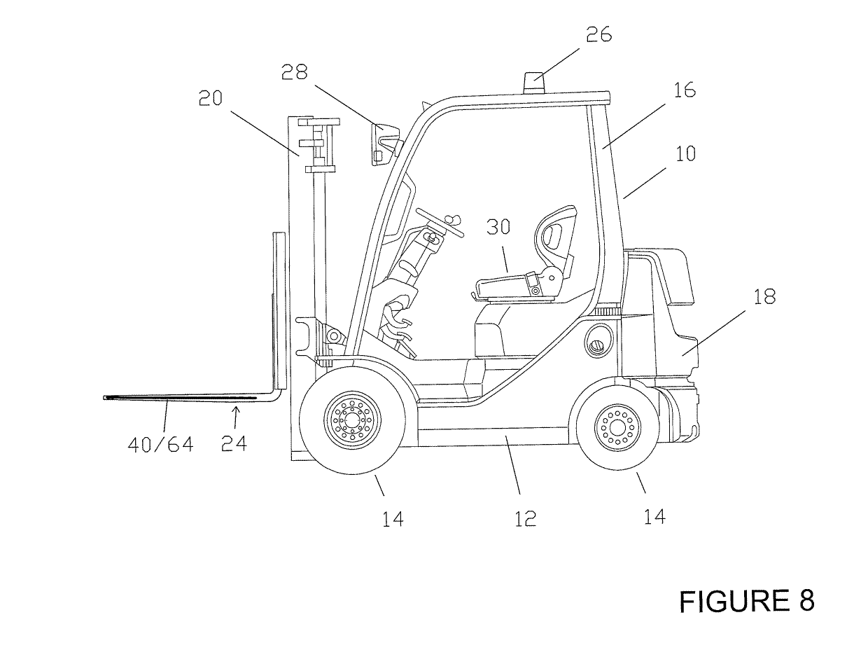

FIG. 8 illustrates a forklift truck in accordance with the invention, corresponding to the forklift truck shown in FIG. 1 with the addition of LED strip 40 or 64 (integrated or retrofitted) extending along the outer side surface of the fork lifting limb 36.

Consider the case of a conventional forklift in which the horizontal distance from the leading edge or tip of the fork 24 to the warning light 26 mounted on the cab is approximately 2440 mm. If the forklift emerges from behind an obstruction into the path of a pedestrian, for a forklift travelling at 5 mph (2.2352 m/s), the time taken from the leading edge of the fork emerging to the warning light coming into view is just over 1.1 second. This provides very little time for a pedestrian to take action. By this time, in a typical case, nearly 75% of the overall length of the vehicle is in the path of the pedestrian, and there is a high probability that the forklift may have come into contact with the pedestrian.

By contrast, with a forklift in accordance with the invention, in which the horizontal distance between the tip of the fork 24 and the LED strip 40 or 64 is 50 mm, in the same conditions the time taken for the strip 40 or 64 to come into view is just over 0.022 seconds. For a pedestrian walking at 4 mph (1.788 m/s), the pedestrian will see the warning strip 40 or 64 approximately 1.8 metres earlier than a cab-mounted light, enabling the pedestrian to stop in time. The likelihood of collisions is thus substantially reduced.

In all embodiments, the LEDs or LED strips may be encapsulated in transparent or translucent resin, silicon or other suitable material (possibly clear or coloured) providing protection against mechanical damage, moisture, weather, etc.

In all embodiments, an optional protective covering or window (not shown) may be provided over the LED strips. For example, a cover member, possibly of transparent or translucent plastics material, such as Perspex, polycarbonate, etc., or of apertured metal, may be secured in position e.g. by welding, adhesive or the use of screws, clips or other fasteners, etc. Preferably the LED strips and cover members are located within a recessed portion of the fork surface, e.g. slot 48 or slot 52, so as not to protrude from the recessed portion and ideally presenting a flush surface.

The LED strip can be configured with one or more circuits so different LEDs can easily be controlled independently for example red and white LEDs can be connected to different circuits so that by connecting one circuit the strip emits red light and connecting the other circuit the strip emits white light.

Alternatively, RGB LEDs can be utilised offering the primary colours when connected directly, as well as the full spectrum of colours including white by varying the intensity of each colour.

The LED strip can contain one or more single colour LEDs or be fitted with RGB LEDs or a combination of RGB LEDs and a single colour LEDs, for example white.

Depending on the application, the LEDs can be single colour for example red or two or more different colours for example red and white which are connected on different circuits allowing either one or more colour(s) to be illuminated. Alternatively RGB LEDs can be utilised offering the full spectrum of colours.

The illuminated LED strip can be controlled manually by the forklift operator or automatically when the forklift is on operation.

The LEDs can be illuminated continuously or pulsed to attract attention. The standard pulse frequency for warning devices is around 1 Hz, but the frequency chosen can be from 100 to 0.01 Hz depending on the application. Pulsing is conveniently at a frequency of around 1-4 Hz. Pulsing can be single or double pulsed.

In a particular embodiment, using a red LED strip 40 900 mm in length having a light output of 720 lumens/m, the output is 648 candela, while for a white LED strip 40 900 mm in length having a light output of 960 lumens/m, the output is 864 lumens, both of which have good conspicuity in both daylight and night (dark) conditions. These figures quoted at a constant output but the LEDs can be driven harder under flash condition, offering an increased output and as LED technology develops further the output of the devices will increase also.

The LED strip may be digitally controlled and addressed via a bus network so that each individual LED or group of LEDs is individually controllable for colour and intensity.

The system could be controlled with a basic control system, so that when the forklift ignition is on the strip is illuminated either flashing or constant. The flash pattern and rate can be set by switches or programming. When the ignition is switched off, then the strip is powered off.

The system could be controlled with an integrated control system so that, for example, when the ignition is operated, the light bars flash one colour, for example red offering a high visual indication to pedestrians that a forklift is approaching and the position of the forks. The flash pattern and rate can be set by switches or programming.

The system can be configured as a multipurpose integrated system so that when the forklift is moving the light bars flash one colour, for example red offering a high visual indication to pedestrians that a forklift is approaching and the position of the forks. When a pallet is to be loaded, the operator positions the forklift in the correct position, raises or lowers the forks and adjusts the angle of the mast to align the tips if the forks with the pallet aperture. The integrated control system may be arranged to detect if the forks have been raised or lowered or the mast angle altered and, in response thereto, change the light bars from flashing red to permanent white for a set period of time for example 20 seconds providing a “precision” work light allowing the operator to quickly and safely position the forks in the correct alignment reducing the risk of the forks pushing the pallet backwards, dislodging the pallet or a pallet directly behind it creating a serious hazard to the fork lift operator any workers or pedestrians in the vicinity. The set period of time can be from 0.1 to 6000 seconds. The system could automatically return to flashing red before the timer has elapsed if it detected the forklift was moving for a set period of time or has reached a chosen speed.

The integrated control system could automatically return to flashing red before the timer has elapsed if it has detected the forklift was moving at a predetermined speed.

The integrated control system could also be configured to allow all or selected LEDs to remain illuminated at full brightness or dimmed when the ignition is off and the forklift is parked up.

We will now consider possible control systems for the illuminated fork arrangements discussed above.

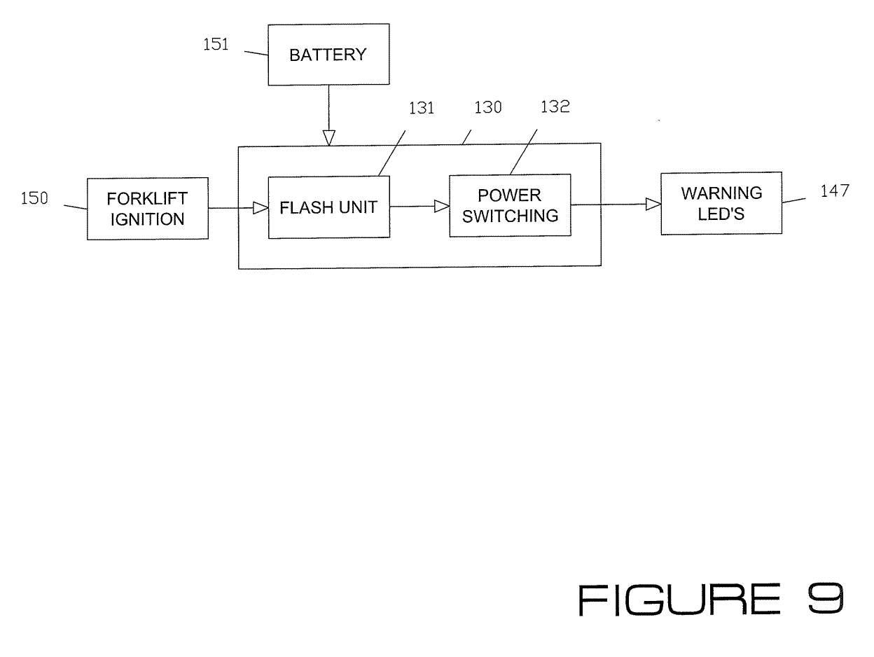

FIG. 9 shows a block diagram of a basic control system 130 which is connected to the vehicle's battery 151, a rechargeable battery pack, a non-rechargeable battery pack or any other suitable means. The basic control system 130 consists of a flash unit module 131 and power switching module 132. The basic control system 130 has a direct or indirect input from the forklift's ignition circuit 150 which when powered switches the basic control system 130 on automatically. The basic control system 130 could alternatively be powered directly from the ignition circuit input 150.

The flash unit 131 can be configured to provide various flash patterns with either single, double or more pulses and frequencies ranging from 0.1 to 20 Hz. The flash unit 131 can be a discreet electronic design or microcontroller based so the flash pattern and rate can easily be configured by software. The flash unit 131 module is connected to the power switching module 132 which provides the output to the warning LEDs 147. When the power is removed from the forklifts ignition circuit 150 the basic control system 130 powers off and the warning LEDs 147 are switched off.

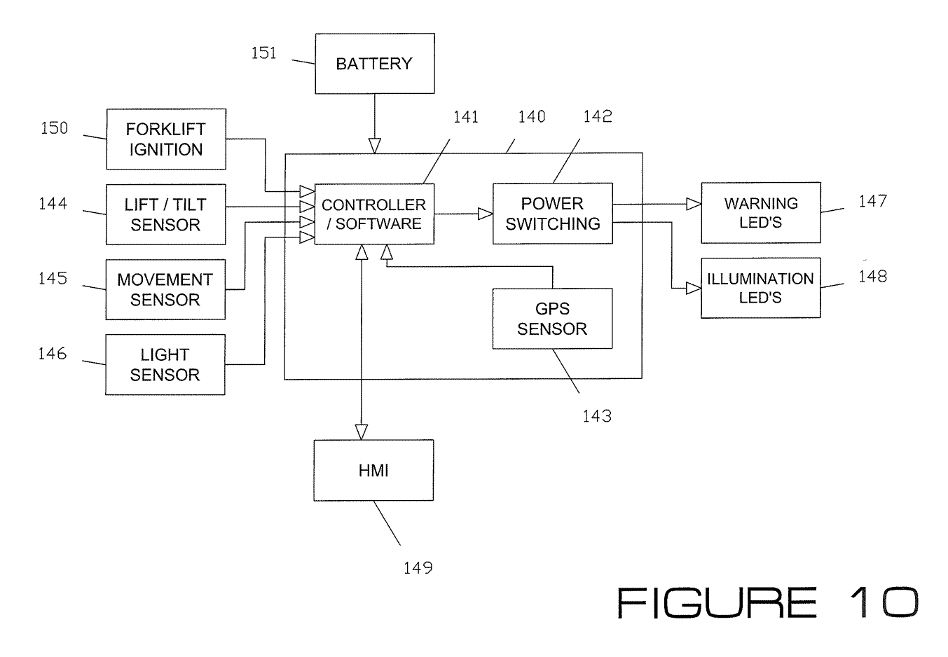

FIG. 10 shows a block diagram of an integrated control system 140 which is connected to the vehicle's battery 151, a rechargeable or non-rechargeable battery pack or any other suitable means. The integrated control system 140 consists of a controller or a software module 141, power switching module 142 and electronic movement sensor 143.

The integrated control system 140 has a direct or indirect input from the forklift's ignition circuit 150, which when powered switches the integrated control system 140 on automatically. The integrated control system 140 could alternatively be powered directly from the ignition circuit 150.

The integrated control system 140 can be configured with various inputs, including forklift ignition circuit 150, lift/tilt sensor 144, movement sensor 145, light sensor 146 and can have an HMI interface 149 if required.

The integrated control system 140 can be configured with two main outputs for warning LEDs 147 and illumination LEDs 148 although additional outputs can be added if required.

The controller/software module 141 can be a discreet electronic design or microcontroller based. The controller/software module 141 is connected to the power switching module 132 which provides the output to the warning LEDs 147 and/or illumination LEDs 148.

The lift/tilt sensor 144 input are controlled by signals which are received when the operator raises or lowers the carriage or tilts the mast forward or backward. These signals can be received via various technologies including, discreet switches, a non-contact inductive sensor, capacitive sensor, optical sensor, motion sensor, angular sensor, linear sensor and infrared sensor or flow technology detecting fluid flow to the rams or any other suitable means.

The movement sensor 145 is provided to measure when the forklift wheels are turning and can give the controller a simple signal that the wheels are turning or more complex information on vehicle speed.

A light sensor 146 is provided to provide the integrated control system 140 of ambient lighting conditions.

We will now discus the operation of the integrated control system 140 in which the unit is connected to the vehicle's battery 151. When the forklift ignition is turned then a forklift ignition signal is received to the controller/software module 141 which via the power switching module 142 switches on the warning LEDs 147 at the predetermined flash pattern and pulse rate. The warning LEDs will remain on whilst the vehicle is driven.

When the operator requires to pick a pallet from a rack, the operator positions the forklift in a position in front of the pallet and raises or lowers the carriage or tilts the mast forward or backward and this via the lift/tilt sensor 144 sends a signal to the to the controller/software module 141 which switches the output via the power switching module 142 to the warning LEDs 147 off and switches the output via the power switching module 142 to the illumination LEDs 148 on.

The illumination LEDs are intentionally white, permanently on and provide illumination to enable the operator to quickly and safely locate the pallet aperture and insert the forks. Alternatively the illumination LEDs 148 can be any colour and flashing if required. The warning LEDs 147 can also be used as illumination LEDs by simply switching the output from flashing to static mode.

After the operator has positioned the forks in the correct position they slowly move the forklift forward to engage the forks in the pallet aperture. In this mode, the integrated control system 140 will provides LED illumination 148 lights for a set period of time and the operator slowly moves the forklift forward to engage the forks in the pallet aperture and subsequently lifts it off the rack, reverses and lowers the pallet to around 300 mm off the ground and then drives to the unload destination.

When the integrated control system 140 has detected the forklift is moving at a certain velocity, determined by either the internal electronic movement sensor 143 or the external movement sensor 145, it switches the output via the power switching module 142 to the warning LEDs 147 on and switches the output via the power switching module 142 to the illumination LEDs 148 off. Should the operator adjust the carriage position or tilt whilst the forklift is in motion above a certain velocity then no change will occur.

The integrated control system 140 can use the electronic movement sensor 143 to measure the velocity of the forklift instead of using a movement sensor 145.

The integrated control system 140 has an input for an optional light sensor 146 to measure the ambient lighting levels and adjust the brightness of warning LEDs 147 or illumination LEDs 148 if required.

The integrated control system 140 has an input for an optional light sensor 146 to change the colour of the warning LEDs 147 and/or illumination LEDs 148 between varying lighting conditions if required.

The integrated control system 140 could also be configured to allow all or selected LEDs to remain illuminated at full or reduced brightness when the forklift is parked up and the ignition key removed. This feature could be integrated with information received from the light sensor 146.

It is to be recognized that various alterations, modifications, and/or additions may be introduced into the constructions and arrangements of parts described above which are merely illustrative of numerous and varied other embodiments which may constitute applications of the principles of the invention. Such other embodiments may be readily devised by those skilled in the art without departing from the spirit or scope of the present invention, and it is to be understood that, within the scope of the appended claims, the invention may be practiced other than as specifically described herein.

1. A forklift apparatus for lifting a pallet or load, the apparatus comprising a self-propelled main body on ground-engaging wheels, a pair of similar side-by-side lifting forks for lifting said pallet or load, a light-emitting arrangement and a control system, wherein;
the main body comprises a mast and a carriage, the carriage being mounted on the mast for movement between a lowered position at or near the ground and a raised position;
said lifting forks are attached to the carriage to move up and down with the carriage between said lowered and raised positions, each lifting fork being elongate in a direction extending away from the main body and each having an outer side surface projecting beyond the footprint of the main body;
the angle of the mast with respect to vertical is adjustable;
the light-emitting arrangement comprises a pair of elongate light strips, each light strip being fixed with respect to a corresponding one of said outer side surfaces along the length of said lifting forks so as to be visible from both sides; and
the control system is configured to:
(a) operate the light strips in different modes, said modes comprising a flashing mode in which a flashing light is visible from both sides of said lifting forks for warning pedestrians and a static mode in which an outwards illumination is provided from both sides of said lifting forks when engaging said lifting forks with said pallet or load; and
(b) operate the light strips in the flashing mode for warning pedestrians until the control system detects that said lifting forks have been raised or lowered or the mast angle has been altered and then to operate the light strips in the static mode for a set period of time for helping position said lifting forks in the correct alignment with a pallet or load to be lifted.

2. The forklift apparatus according to claim 1, wherein the control system comprises a lift/tilt sensor that has an input that receives signals when the carriage is raised or lowered or when the mast tilts forward or backward.

3. The forklift apparatus according to claim 1, wherein the control system is configured to automatically return to the flashing mode before the end of said set period of time if the control system detects that said self-propelled main body is moving at a first predetermined velocity.

4. The forklift apparatus according to claim 1, wherein the control system is configured to automatically return to the flashing mode before the end of said set period of time if the control system detects that said self-propelled main body is moving for a set period of time.

5. The forklift apparatus according to claim 3, wherein the control system is configured to maintain the flashing mode when the control system detects that said lifting forks have been raised or lowered or the mast angle altered if the control system detects that said self-propelled main body is moving above a second predetermined velocity.

6. The forklift apparatus according to claim 4, wherein the control system comprises an electronic movement sensor for measuring when said wheels are turning.

7. The forklift apparatus according to claim 1, wherein each outer side surface is of elongate form, having a major dimension extending away from the main body and a minor dimension extending transversely thereto, with the corresponding light strip also being elongate in the same direction with an aspect ratio of at least 20:1.

8. The forklift apparatus according to claim 1, wherein the light-emitting arrangement comprises a light strip fixed with respect to a front surface of a distal end of each of said lifting forks so as to be visible from said distal end.

9. The forklift apparatus according to claim 1, wherein each light strip comprises a linear array of light sources.

10. The forklift apparatus according to claim 9, wherein the linear array of light sources comprises a plurality of LEDs.

11. The forklift apparatus according to claim 10, wherein said LEDs comprise a plurality of illumination LEDs and a plurality of warning LEDs, said illumination LEDs providing said illumination during said static mode and said warning LEDs providing said flashing light during said flashing mode.

12. The forklift apparatus according to claim 1, wherein each light strip is located in a recessed portion of the surface to which said light strip is fixed.

13. The forklift apparatus according to claim 1, further comprising a protective covering over each light strip.

14. The forklift apparatus according to claim 1, wherein the control system is arranged to control the light strips to produce a red colour of light in the flashing mode and a white colour of light in the static mode.

15. A method of operating a forklift apparatus, the apparatus comprising a self-propelled main body on ground-engaging wheels, a pair of similar side-by-side lifting forks for lifting a pallet or load, a light-emitting arrangement and a control system, wherein;
the main body comprises a mast and a carriage, the carriage being mounted on the mast for movement between a lowered position at or near the ground and a raised position;
said lifting forks are attached to the carriage to move up and down with the carriage between said lowered and raised positions, each lifting fork being elongate in a direction extending away from the main body and each having an outer side surface projecting beyond the footprint of the main body;
the angle of the mast with respect to vertical is adjustable;
the light-emitting arrangement comprises a pair of elongate light strips, each light strip being fixed with respect to a corresponding one of said outer side surfaces along the length of said lifting forks so as to be visible from both sides; and
wherein the method comprises using the control system to:
(a) operate the light strips in a flashing mode in which a flashing light is visible from both sides of said lifting forks for warning pedestrians as the self-propelled main body moves across the ground; and
(b) detect when said lifting forks have been raised or lowered or the mast angle has been altered and then to operate the light strips in a static mode to provide outwards illumination from both sides of said lifting forks for a set period of time to help position said lifting forks in the correct alignment with a pallet or load to be lifted.

16. The forklift apparatus according to claim 2, wherein the control system is configured to automatically return to the flashing mode before the end of said set period of time if the control system detects that said self-propelled main body is moving at a first predetermined velocity

17. The forklift apparatus according to claim 2, wherein the control system is configured to automatically return to the flashing mode before the end of said set period of time if the control system detects that said self-propelled main body is moving for a set period of time.

18. The forklift apparatus according to claim 5, wherein the control system comprises an electronic movement sensor for measuring when said wheels are turning.

19. The method of claim 15, wherein the method comprises, after step (b), the step of using the control system to automatically return to the flashing mode before the end of said set period of time if the control system detects that said self-propelled main body is moving at a first predetermined velocity.

20. The method of claim 19, wherein the method comprises, during step (a), the step of using the control system to maintain the flashing mode when the control system detects that said lifting forks have been raised or lowered or the mast angle altered if the control system also detects that said self-propelled main body is moving above a second predetermined velocity.
